(19) United States
(12) Patent Application Publication
(10) Pub. No.: US 2019/0360234 A1
(43) Pub. Date: Nov. 28, 2019

(54) Hardware Handle

(71) Applicant: Sigal Alkoby, Tarzana, CA (US)

(72) Inventor: Sigal Alkoby, Tarzana, CA (US)

(21) Appl. No.: 15/988,847

(22) Filed: May 24, 2018

(51) Int. Cl. E05B 1/00; A47B 95/02

(52) U.S. Cl. CPC E05B 1/0015; A47B 95/02; E05Y 2900/20; A47B 2220/0047; E05Y 2900/132; A47B 2095/024

(57) ABSTRACT

A hardware handle that is attached to a surface of an object or structure. The hardware handle includes a longitudinal member with an outer surface, an inner surface, a first end and second end. A first securing post attached to and perpendicularly extending from the longitudinal member first end, and a second securing post attached to a perpendicularly extending from the longitudinal member second end, can also be included. A threaded opening on the first and second end, or on each securing post facilitates the hardware handle being attached to an object or structure by use of a screw. An adhesive can also be utilized. Located on the inner surface and extending the length of the longitudinal member is a slot. A section of material is wrapped around the longitudinal member, with the two ends of the material inserted into and captively maintained within the slot. The insertion and maintaining of the two ends of material within the slot creates a smooth surrounding surface of the material, with no bumps or creases would occur when overlaying the ends of material.

### TECHNICAL FIELD

The invention generally pertains to handles, and more particularly a hardware handle having a material wrapping with no bumps or creases where ends of the material are overlaid.

### BACKGROUND ART

One of the most common devices utilized for a variety of purposes is a handle. By placing a handle on an object or structure, a person is able to manipulate the object or structure. Two of the most typical applications of a handle are on a door or a cabinet/drawer. In the past, handles were usually viewed as a utilitarian device, so the design and/or appearance was often basic. As times have progressed, and people have taken a greater interest in the overall appearance of, in particular, their homes, there has developed a desire for handles with a more distinct aesthetic appearance. As a result, handles are now available in a variety of shapes and sizes, and made from a variety of materials.

One relatively recent way of adding embellishment to a handle is to wrap the gripping portion of the handle with a material, such as leather. By wrapping a handle with material, the appearance of the handle can be significantly improved and a person can easily color-coordinate a handle within an environment. Also, a material wrapped handle provides a softer tactile experience when using the handle.

A problem does exist though: when wrapping a material around a handle, the two ends of the material must be overlaid, which results in a pronounced bump or creases which detract from the desired consistent smooth gripping surface. What is needed is a material wrapped handle that is consistency smooth all the way around the gripping portion. A method that would produce this type of wrapping would be very beneficial, and would provide a person with the ability to possess and use a handle that would not have any negative attributes which detract from the appearance and feel of the handle.

A search of the prior art did not disclose any literature or patents that read directly on the claims of the instant invention. However, the following U.S. patents are considered related:

| PAT. NO. | INVENTOR | ISSUED |
|---|---|---|
| 4,651,991 | McDuff | Mar. 24, 1987 |
| 5,394,769 | Cropley | Mar. 7, 1995 |
| 6,167,592 | Tsai | Jan. 2, 2001 |

The U.S. Pat. No. 4,651,991 patent discloses a secondary covering for the gripped portion of manipulative handles having a primary non-slip covering that is comprised of an elongated strip of terrycloth fabric having at each extremity and two lengths of strong thin tether line attached to each extremity. The covering is adapted to be wound in spiral fashion about the handle, both extremities being secured by the tether lines to the handle, the tether lines of the upper extremity of the winding being secured with plastic adhesive tape.

The U.S. Pat. No. 5,394,769 patent discloses a handle that includes an elongate recessed body portion of a substantially open-faced “U” configuration and an elongate cover portion of a substantially open-faced inverted “U” configuration. Reinforcements are provided within both the body portion and the cover portion with the outer sides formed and profiled so as to allow for substantial open-face to open-face engagement therebetween.

The U.S. Pat. No. 6,167,592 patent discloses a handle with a body which is formed of two shell members such that the body is provided therein with a receiving space, and in the surface of a grip portion thereof with two slits opposite to each other and extending along the grip portion. The grip portion is covered by a covering which has two side edges along the longitudinal axis. The two side edges of the covering are concealed in the receiving space via the slits such that the two side edges form a tubular structure and the two side edges are retained in place by a retaining rod located in the receiving space.

For background purposes and indicative of the art to which the invention relates, reference may be made to the following remaining patents found in the patent search.

| PAT. NO. | INVENTOR | ISSUED |
|---|---|---|
| 2,771,627 | Hammer | Nov. 27, 1956 |
| 3,098,686 | Benoit | Jul. 23, 1963 |
| 3,107,389 | Engelbrecht | Oct. 22, 1963 |
| 4,379,603 | Johnson et al | Apr. 12, 1983 |
| 2003/0177611 | Lin | Sep. 25, 2003 |

### DISCLOSURE OF THE INVENTION

A hardware handle that is attached to a surface of an object or structure to facilitate manipulation, such as opening or closing, of the object or structure. The hardware handle has a material wrapping around the gripping portion with no bumps or creases on any surrounding surface of the material. In a first embodiment, the hardware handle includes a longitudinal member with an outer surface, an inner surface, a first end and a second end. Attachment means typically comprising an adhesive or a screw are used to secure the hardware handle to an object or structure, such as a door or a cabinet/drawer. A recessed slot is located on the longitudinal member inner surface. When the material is wrapped around the longitudinal member, the two ends of the material are inserted into and captively maintained within the slot. By this method there are no bumps or creases created which would be present if the two ends of the material were overlaid in a conventional manner.

A second embodiment of the hardware handle utilizes the same slot design, but includes the addition of a first securing post and a second securing post. The two securing posts are respectfully located at, and extend perpendicularly from, the longitudinal member first end and second end. The two securing posts interface with and are attached to an object or structure. As with the first embodiment, the second embodiment can be secured on the object or structure by an adhesive, or by screws that correspond to a threaded opening on each securing post.

The hardware handle can be made of a variety of materials including metal, plastic, wood or a composite. The material that is wrapped around the longitudinal member is preferably leather, but any material can be effectively utilized.

In view of the above disclosure, the primary object of the invention is to produce a hardware handle that includes a slot into which two ends of a material wrapping are inserted and maintained, thereby creating a consistency smooth material surface around the handle, with no bumps or creases on the material.

In addition to the primary object, it is also an object of the invention to produce a hardware handle including a slot that:
is easy to install,
can be custom made to a person's specifications including size, shape, and type or color of material wrapping,
can be used in any application where a conventional handle is required or desired.
is durable and long-lasting,
can be sold as an OEM item on an object or structure, or as an aftermarket, user-installable product,
does not significantly increase the manufacturing cost of a handle,
can be quickly and easily replaced if necessary,
can dramatically improve the appearance of an environment in which they are used,
provide a smooth, comfortable gripping surface on the handle,
adds to the available options for interior designers,
are cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a rear elevational view of a first embodiment of a hardware handle with a recessed slot extending along a lower surface of the handle's longitudinal member.

FIG. 2 is a rear elevational view of the hardware handle shown in FIG. 1 with an interface member extending outward from the handle's first end and second end. The interface member facilitates the attachment of a decorative end-piece at each end.

FIG. 3 is a rear orthographic view of the hardware handle with a decorative end-piece attached to the handle's longitudinal member first end and second end, and a recessed slot extending along a lower surface of the handle's longitudinal member.

FIG. 4 is a rear orthographic view of a second embodiment of the hardware handle with a material wrapping around the longitudinal member and securing posts extending downward from the longitudinal member's first end and second end.

FIG. 5 is an orthographic rear view of the hardware handle with decorative end-pieces at each end, and a cover over the slot on the rear surface of the longitudinal member.

FIG. 6 is an orthographic view of the hardware handle without material wrapping, and an alternate style decorative end-piece attached to securing a securing post at the longitudinal member's first end and second end.

FIG. 7 is an orthographic rear view of the hardware handle with decorative end-pieces at each end, and a cover over the slot on the rear surface of the longitudinal member.

### BEST MODE FOR CARRYING OUT THE INVENTION

The best mode for carrying out the invention is presented in terms that disclose a first and second embodiment of a hardware handle. As with other conventional handles, the hardware handle is attached to surface of an object of structure to facilitate manipulation, such as opening or closing, of the object or structure. The inventive concept of the hardware handle 10 is that a section of material is wrapped around the gripping portion of the handle, and the material completely surrounds the gripping portion with a consistency smooth material surface, with no bumps or creases.

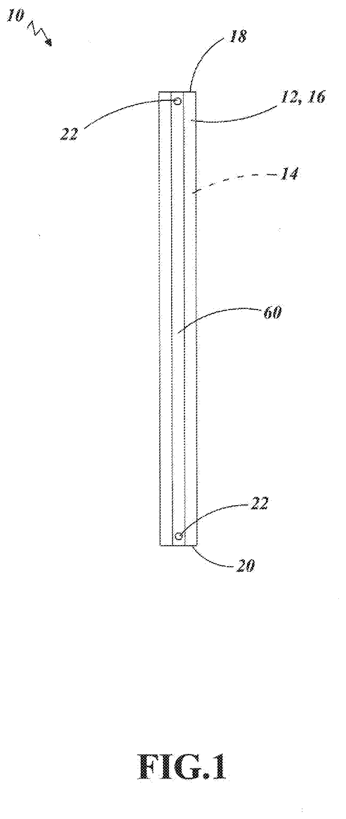

The first embodiment of the hardware handle 10, as shown in FIGS. 1 7, is comprised of a longitudinal member 12 which functions as the gripping portion and has an outer surface 14, an inner surface 16, a first end 18 and a second end 20. Both the first end 18 and the second end 20 each have a threaded opening 22.

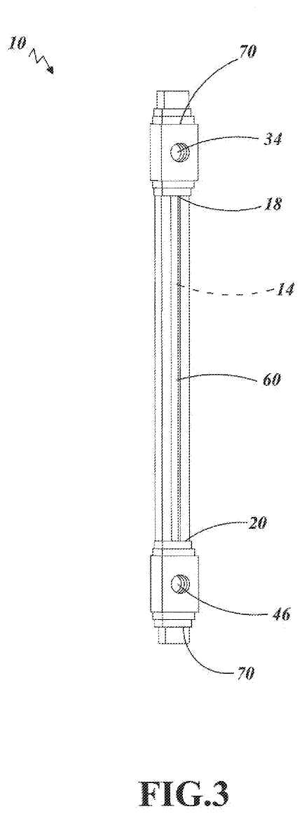

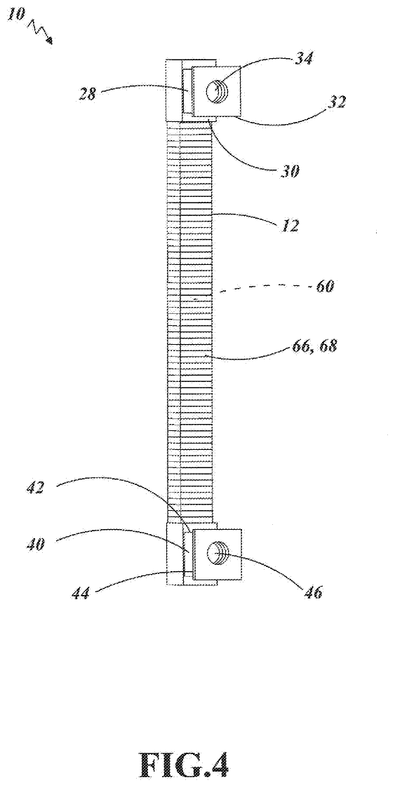

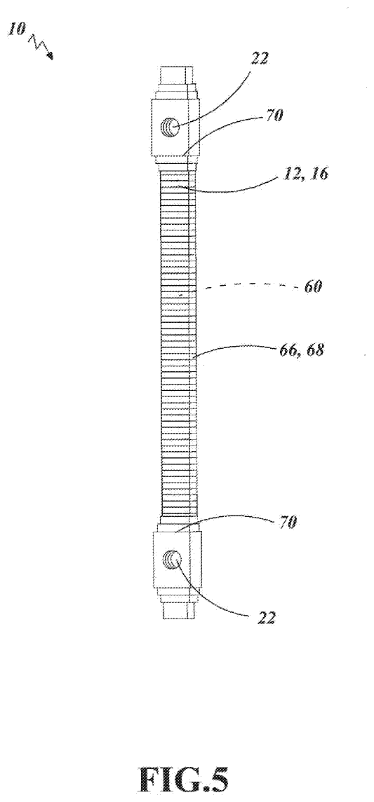

Located on the inner surface 18 and extending the substantial length of the longitudinal member 12 is a recessed slot 60, as shown in FIGS. 1 and 3. A section of material 66 is wrapped around the longitudinal member 12, as shown in FIGS. 4 and 5, with the two ends of the material 66 inserted into and maintained within the slot 60 by attachment means 68. Preferably the attachment means 68 is comprised of an adhesive, but other means such as a countersunk screw could also be utilized. The insertion and maintaining of the two ends of material 66 within the recessed slot 60 creases a substantially smooth surrounding surface of the material 66 with no bumps or creases which would occur when overlaying two ends of material in a conventional method.

In the first embodiment, the hardware handle 10 is attached to an object or structure either by an adhesive applied at each end 18,20, or by use of a corresponding screw that is rotatably inserted through an opening in the object or structure and into the threaded opening 11 on each end 18,20, as shown in FIG. 1.

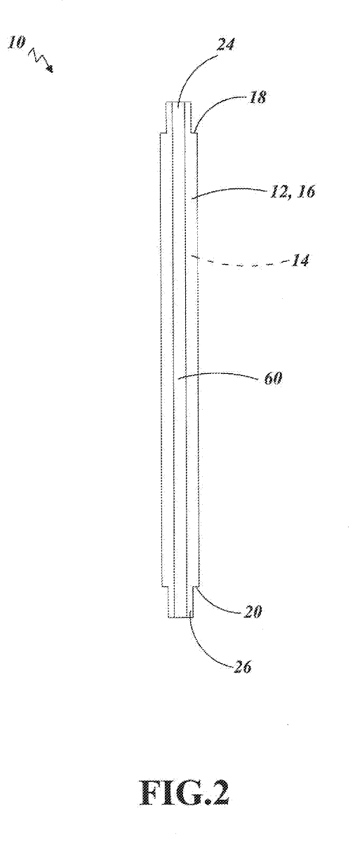

The second embodiment of the hardware handle 10, as shown in FIGS. 2 and 4, utilizes the same type of longitudinal member 12 with the recessed slot 60 design. The difference is that the second embodiment also includes a first securing post 28 with an upper end 30 and a lower end 32 having a threaded opening 34, and a second securing post 40 with an upper end 42 and a lower end 44 having a threaded opening 46. The first and second securing posts 28,40 are attached to the respective first end 18 and second end 20 of the longitudinal member 12 by attachment means 50 that can include an adhesive 52 on at least one screw. Other means such as a bolt or nut can also be utilized, or the securing posts can be press-fit 56 onto the ends. Also, the securing posts 28,40 can be integrally attached during manufacturing. The second embodiment can also be attached by an adhesive on the lower end 32,44 of each securing post, or by use of a screw that is rotatably inserted into the threaded openings on the securing posts. As shown in FIGS. 2 and 4, the second embodiment provides a greater distance between the longitudinal member 12 and the surface of the object or structure. This allows a person to completely grip around the material wrapped longitudinal member and experience the entirely/consistency smooth material surface. The first embodiment also allows this but offers a shallower attachment of the hardware handle when an application requires it.

Both embodiments of the hardware handle 10 can be made of a variety of materials including metal, plastic, wood or a composite. Also, the type of material can vary. Preferably leather is used, but other materials including woven, or metallic foils can be utilized. This is one of the greatest benefits of the hardware handle 10. As a result of the recessed slot design, any material can be wrapped around the hardware handle 10 and have a completely smooth material surface, as shown in FIGS. 3 and 4. Prior conventional material wrapped handles used a wrapping method that resulted in the two ends of the material being overlaid, since there was no other way of adequately securing the two ends. This results in a double-thickness bump at the location of the overlay, and/or creases in the material.

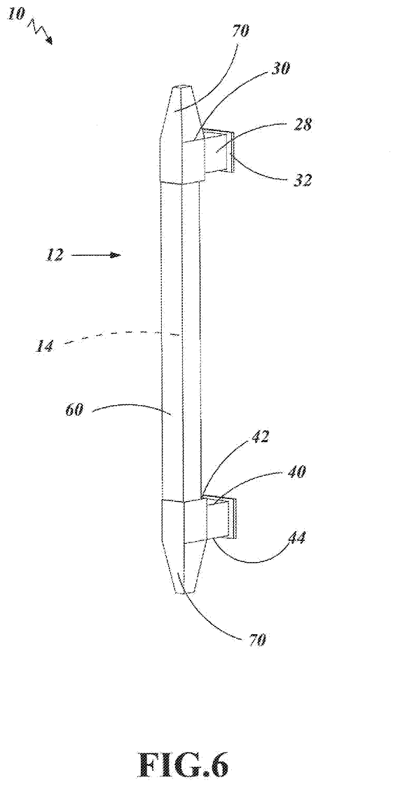

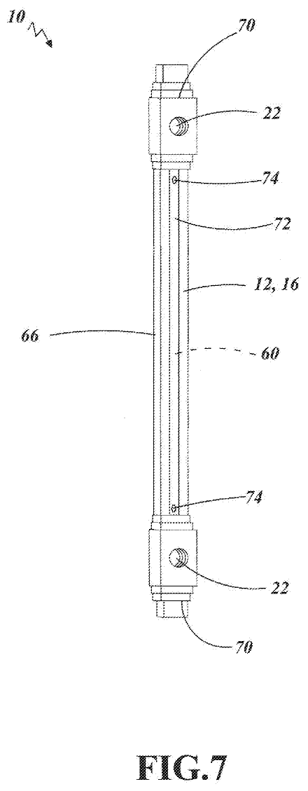

To add to the functionality and aesthetic appearance of the hardware handle 10, a decorative end-piece 70 can be utilized. As shown in FIGS. 3, 5, 6 and 7, the end-piece 70 is located at the first and second ends 18,20 of the longitudinal member 12. In order to secure the decorative end-piece 70 on the longitudinal member 12, an interface member 24 is utilized. As shown in FIG. 2, the interface member is integrally attached and is preferably smaller than the longitudinal member. The interface member 24 is dimensioned to be inserted into and maintained within an opening on the end-piece. An example of a decorative end-piece 70 design, as shown in FIGS. 5 and 7, includes a center section with outward extending steps. Another end-piece design, as shown in FIG. 6, has an inward taper. It should be noted that there are only two examples of the design and type of decorative end-piece that can be utilized, and in fact the design of the entire handle can be custom made to the requirements or desire of an individual or a particular application.

Additionally, to add further functionality, a cover 72, as shown in FIG. 5, can be placed over or on the slot 60 after the two ends of the material have been inserted. The cover 72 can function as the attachment means for maintaining the material 66 within the slot 60, or the cover 72 can be used as an aesthetic extension to hide the location where the two ends of the material have been inserted and are maintained. The cover 72 can be held in place over or on the slot 60 by an adhesive, by screws, or even by press-fitting the cover into the slot.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A hardware handle comprising:
a longitudinal member comprising:
an outer surface,
an inner surface comprising a recessed slot extending a substantial length of the longitudinal member,
a first end with a threaded opening; and
a second end with a threaded opening, and
a section of material with a first end and a second end, the section of material wrapped around the longitudinal member with each of the first and second ends inserted and maintained within the recessed slot by an attachment means, the inserting and maintaining creating a substantially smooth surrounding surface of the material with no bump or crease.

2. The hardware handle of claim 1 wherein the hardware handle is made of a material selected from the group consisting of metal, plastic, wood and a composite.

3. The hardware handle of claim 1 wherein the hardware handle has a shape selected from the group consisting of square, circular, semi-circular and triangular.

4. The hardware handle of claim 1 wherein the hardware handle is attached to a surface of an object or structure by an adhesive.

5. The hardware handle of claim 1 wherein the threaded opening functions in combination with a corresponding screw that is rotated into the opening to attach the hardware handle to a surface of an object or structure.

6. The hardware handle of claim 1 further comprising a decorative end-piece that is located at the first end and the second end, wherein extending outward from the first end and the second end is an interface member that is dimensioned to be inserted and maintained by press-fit within an opening on the decorative end-piece, wherein a threaded opening on the end-piece allows a screw to be inserted through an opening on an object or structure and into the threaded opening on the end-piece, thereby securing the end-piece to a surface of the object or structure.

7. A hardware handle comprising:
a longitudinal member with an outer surface, an inner surface, a first end, and a second end,
a first securing post with an upper end and a lower end having a threaded opening, the first securing post is attached by attachment means to, and extends perpendicularly outward from the longitudinal member first end,
a second securing post with an upper end and a lower end having a threaded opening, the second securing post is attached by attachment means to, and extends perpendicularly outward from the longitudinal member second end, and
a recessed slot that is located on the longitudinal member inner surface, and extends the substantial length of the longitudinal member, a section of material is wrapped around the longitudinal member, with two ends of the material inserted into and maintained within the recessed slot by attachment means, the insertion and maintaining of the material within the slot creates a substantially smooth surrounding surface of the material with no bumps or creases which would occur when overlaying two ends of material.

8. The hardware handle of claim 7 wherein the hardware handle is made of a material selected from the group consisting of metal, plastic, wood and a composite.

9. The hardware handle of claim 7 wherein the hardware handle has a shape selected from the group consisting of square, circular, semi-circular and triangular.

10. The hardware handle of claim 7 wherein the material is selected from the group consisting of leather, woven fabric, non-woven fabric, plastic, and nylon.

11. The hardware handle of claim 7 wherein the first securing post is attached to the longitudinal member first end by attachment means comprising an adhesive.

12. The hardware handle of claim 7 wherein the first securing post is attached to the longitudinal member first end by attachment means comprising at least one screw.

13. The hardware handle of claim 7 wherein the first securing post is attached to the longitudinal member first end by press-fit.

14. The hardware handle of claim 7 wherein the first securing post is integrally attached to the longitudinal member first end.

15. The hardware handle of claim 7 wherein the second securing post is attached to the longitudinal member second end by attachment means comprising an adhesive.

16. The hardware handle of claim 7 wherein the second securing post is attached to the longitudinal member second end by attachment means comprising at least one screw.

17. The hardware handle of claim 7 wherein the second securing post is attached to the longitudinal member second end by press-fit.

18. The hardware handle of claim 7 wherein the second securing post is integrally attached to the longitudinal member second end.

19. The hardware handle of claim 7 further comprising a decorative end-piece that is located at the longitudinal member first end and second end, wherein the decorative end-piece interfaces with and is attached to the first securing post and the second securing post.

20. The hardware handle of claim 7 further comprising a cover that is placed over or on the slot after the two ends of the material are inserted, wherein the cover functions as attachment means for maintaining the material within the slot, or the cover is an aesthetic extension to hide the location where the two ends of the material are placed.
